(19) United States
(12) Patent Application Publication
(10) Pub. No.: US 2024/0166400 A1
(43) Pub. Date: May 23, 2024

(54) Method and installation for treating reusable containers with tracking

(71) Applicant: KRONES AG, Neutraubling (DE)

(72) Inventors: Stefan POESCHL, Sinzing (DE); Katarina MEHRINGER, Regensburg (DE)

(21) Appl. No.: 18/282,774

(22) PCT Filed: Mar. 4, 2022
(86) PCT No.: PCT/EP2022/055599

§ 371 Date: Sep. 18, 2023

(30) Foreign Application Priority Data
Mar. 16, 2021 (DE) 10 2021 106 303.5

(51) Int. Cl. B65C 9/40; B65C 3/08; B65C 9/46; B65D 23/14; G06Q 10/30; G09F 3/00; G09F 3/02

(52) U.S. Cl. CPC B65C 9/40; B65C 3/08; B65C 9/46; B65D 23/14; G06Q 10/30; G09F 3/0297; B65C 2009/408; G09F 2003/0273

(57) ABSTRACT

Disclosed is a method for treating containers and, in particular reusable containers, having the steps of: providing a container having at least one first marking which identifies this container; determining at least one first information associated with said first marking, applying a second marking to the container, wherein the second marking is created taking into account the first marking and/or the determined information.

The present invention is directed to a method and an installation for treating containers and, in particular, reusable beverage containers. Numerous methods of this kind are known from the prior art. It is also known from the prior art that containers are treated which are to be tracked at least during part of their service life. Currently, however, reusable bottles, regardless of whether they are PET or glass bottles, cannot be tracked over their complete life cycle. This is due to the fact that corresponding codes which identify such containers are usually located on their labels and thus are no longer present after cleaning processes, at the latest, in which the labels are detached. In general, the labels are removed during treatment of the containers in a washing machine and the individual bottle is therefore no longer identifiable.

Thus, in the prior art for such reusable bottles, it is not possible to track the number of cycles said bottle has passed through. In the prior art, it is also currently not possible to track a reusable bottle over several cycles and to store the “life” thereof in a database, for example.

Such a method is known from EP3413277 A1.

The object of the present invention is therefore to ensure the tracking capability, in particular of reusable bottles, even over several processes or process cycles, if necessary. In addition, a possibility is to be provided to assess even with regard to a reusable bottle, over how many cycles it can be used. According to the invention, the objects are achieved by the subject matter of the independent claims. Advantageous embodiments and developments are the subject matter of the dependent claims.

In a method according to the invention for treating containers and in particular reusable containers, a container is initially provided which has at least one first marking which identifies and in particular uniquely identifies this container.

In a further method step, at least one first information is associated with this first marking and/or at least one data element associated with this marking is determined.

In a further subsequent method step, a second marking is applied to the container, wherein the second marking is created and/or applied taking into account the first marking and/or the first information.

It is thus proposed that two markings are applied to a container, wherein these markings are preferably linked to one another or the second marking is applied on the basis of an information which also results from the first marking. This can be realized, for example, in that when the second marking is stored, it is stored to which first marking this second marking is linked.

In a preferred method, the container is transported or moved, while the first marking and/or its associated first information is determined. Preferably, the marking and/or the information is, for example, a code for tracking the container or the bottle.

In a further preferred method, the first marking is determined (or read out) in a contactless manner and in particular optically determined. This can take place, for example, by means of a camera or another image recording device.

Preferably, the first marking is arranged on an outer wall of the container and/or on the main body of a container. This marking is preferably not removable from the container in a non-destructive manner, i.e., it cannot be removed without the container being destroyed.

Preferably, the above-mentioned method steps proceed in the sequence indicated above, i.e., the container is initially provided with the first marking, then the information associated with the first marking is determined and finally the second marking is arranged (on the container).

In a further preferred method, the first markings or the information which are read from the first markings are stored in a first database. Particularly preferred, also information that are characteristic of the second marking are stored in a database.

Furthermore, links between the first markings and the second markings are preferably also stored in a database. At least some information, preferably at least a group of information and preferably all information from the first and second markings are preferably stored in a storage device. The storage device can, for example, be a database or a cloud. Furthermore, these information are preferably linked to one another.

Thus, in the case of reusable bottles, the entire life cycle can be mapped and is available, even if a label is removed and destroyed.

In a further preferred method, a first marking is associated with at least one second marking. However, it would also be possible for a first marking to be associated with several second markings, for example if different labels are arranged on the container in several product cycles of the product. In this way, tracking of the product is possible.

It is thus proposed that the first marking is preferably already applied during the production of the respective container, for example at a converter. As mentioned in more detail below, a (matrix) code can be applied to the container, for example. Preferably, this first marking is located at a location at which a label is later located and is therefore not visible for the end user.

It is possible for the first marking to be applied to the container by means of lasers, for example. In this way, the container is preferably uniquely marked.

This code or marking is preferably stored in a database as mentioned above and is preferably provided with additional information, for example the information about the second marking, in further process steps.

The second marking can be, for example, a marking on a container label. For example, individual codes can additionally be applied on the labels, for example matrix codes, which are preferably already applied during label printing. In this way, no printing on the containers or the labels must take place during the actual production.

In a preferred embodiment, the first marking is designed such that the distinction between at least 1,000,000 different containers, preferably at least 10,000,000 different containers, preferably at least 100,000,000 different containers, and preferably at least one billion different containers is made possible. This means that the marking must have a corresponding variability, so that, for example, more than one billion different markings are made possible, each still allowing a unique identification of the respective container.

Preferably, the second marking also allows a distinction of at least one million different containers, preferably at least one hundred million different containers and preferably at least one billion different containers.

The containers are preferably reusable bottles, in particular reusable bottles made of plastic or glass.

In a further preferred method, the first marking is or is going to be arranged in a region of the container which has a cross section that deviates or is smaller than a maximum cross section of the container. In this way, the container can be better protected during its handling, since the marking in particular does not come into contact with transport elements such as, for example, lateral guides and the like.

Preferably, at least one and preferably a plurality of information can be read and/or determined from at least one first marking and/or a second marking. Preferably, these information are selected from a group of information and/or characteristic values which are characteristic of a material of the container, for a volume of the container, for a production date of the container, for a content of the container, for ingredients, for an origin of the ingredients, for a production facility and the like.

Preferably, at least one information is readable by means of the second marking, said information being selected from a group of information which is characteristic for the first marking, for the material of the container, for the volume of the container, for the liquid to be filled, for a filling date, for a sales price of the container, for a production location, for a production line and the like.

As mentioned above, the second marking is preferably linked to the first marking, wherein, in particular, a linking via data technology is meant here. For example, an information can be stored in the second marking, indicating that this second marking is linked to a specific first marking.

In a further preferred embodiment, at least one feature characteristic for this first and second marking is stored. In a further preferred method, both markings and/or at least one of the two markings can be derived from the stored data.

In a further preferred method, the container is provided with at least one decor feature and the marking is arranged on this decor feature. Preferably, first the decor element is provided with the marking and then this decor element provided with the marking is arranged on the container. Particular preferably, the providing of the decor element with the marking and/or attaching the decor element to the container is carried out by a labelling device, in particular a labeling machine. However, the use of a (direct) printing machine would also be conceivable. This procedure makes it possible to avoid the markings being applied directly to the rapidly moving containers.

In a further preferred method, the decor element is selected from a group of decor elements containing labels, in particular shoulder and base labels of the containers, container closures and the like. The labels can be both self-adhesive labels and labels to which an adhesive is applied and which are subsequently arranged on the container. In addition, the decor element can also be a sleeve which is placed over the container to be decorated.

In a further preferred method, at least one marking is selected from a group of markings containing matrix codes (QR code, data matrix, Han Xin code), DotCodes, barcodes, combinations thereof and the like. Particularly preferably, both markings are selected from this group of markings. Preferably, at least one marking and preferably both markings can be read out optically and/or contactlessly.

In a further preferred method, the first marking is at least partially and preferably completely concealed by the decor element. Advantageously, the first marking can be located in the region of the main body of the container, for example, on which a label is also arranged. The first marking is thus preferably not visible and/or not visible on the decorated container.

In at least one later method step, the second marking is preferably removed again from the reusable container. This removal can take place, for example, by means of a cleaning process in which the decor element (with the marking arranged thereon) is removed from the container.

The present invention is further directed to an apparatus for treating containers which has a first treatment unit which treats the containers in a first predetermined manner and which has a decorating device which provides the containers with a decor element, as well as a transport device which transports the containers in a predetermined transport direction.

According to the invention, the apparatus has a detection device which is arranged upstream of the decorating device in this transport direction and is suitable and intended to detect a first marking arranged on the containers, wherein a marking device is provided which is suitable and intended for applying a second marking to or on the decor element.

The first treatment device can be, for example, a filling device which fills containers with a liquid and in particular a beverage. In addition, the first treatment device can also be a closing device for closing containers, or a sterilization device for sterilizing containers.

In a further preferred embodiment, the apparatus has a determination and/or a calculation device which calculates the second marking or determines the shape thereof, wherein this determination and/or calculation device for this determination or calculation uses at least one information characteristic for the first marking.

The apparatus preferably has an association device which associates at least one (first) marking with one and preferably each second marking. In this way, a plurality of second markings can be associated with a first marking, wherein preferably each of these second markings is characteristic for a further cycle of a reusable container.

Preferably, the decorating device is selected from a group of devices containing labeling machines, printing machines, in particular direct printing machines or the like. The second marking is preferably applied to or in the region of a label stock of this labelling machine. In this way, printing of the containers with the second marking during the ongoing operation or during the transport of the containers can be prevented, as a result of which the application of the second marking is made easier.

In a further preferred apparatus, the apparatus has a storage device in which data characteristic for an association between the first marking and the second marking can be stored. Advantageously, these data can be stored for each individual reusable container. This also makes it possible for these data to be extended for each further data set.

The present invention is further directed to a reusable container with a main body, the receiving volume of which is designed for a foodstuff and in particular a beverage. Furthermore, the reusable container has a container mouth, wherein this container mouth preferably has a smaller cross section than the main body. Furthermore, the reusable container has a first marking which is readable by a read-out device and which identifies, in particular uniquely identifies, this reusable container.

According to the invention, the reusable container has a second readable marking, which preferably also uniquely identifies the container. The first marking can uniquely identify the container independently of a decor feature and the second marking can uniquely identify the container equipped with a decor element. Thus it is possible, for example, for the non-decorated container not provided with a container or with a closure to have the first marking and for this container to be provided with different labels in several cycles, wherein these labels each have the second marking.

According to the invention, the first and the second marking can be linked, in particular logically linked.

Preferably, the first marking is arranged on the container or its main body itself and the second marking is arranged on a decor element of the container. Preferably, the decor element having the second marking covers the first marking at least partially and preferably completely. Furthermore, the first marking is preferably permanently arranged on the container, wherein permanently means that a removal of the marking is generally accompanied by destruction of the container.

In a preferred embodiment, the first marking is a marking arranged on the container by means of an engraving, for example a laser engraving. However, it would also be conceivable for the first marking to be created during the production of the container, for example, during an injection molding process. It is thus preferably proposed that only the marking on the label is relevant for further tracking of a specific decorated container.

However, all data that are linked to the second marking on the label are preferably also linked at the same time, in particular in a database, with the first marking, which is, in particular, located on the container itself. By means of the present invention, a clear tracking of the container is thus possible and the complete service life of a reusable bottle can be traced. Thus it can be determined, as mentioned above, how many cycles a reusable container reaches and which containers have been filled into them, for example.

In a further preferred embodiment, at least one marking and in particular the second marking is also provided with a time stamp which is characteristic, in particular, for a point in time where this marking is applied to a decor element and/or to the container. In this way, in particular a total service life of the container itself and also for each individual cycle can be calculated or determined. Preferably, said points in time are also stored in a database and/or can be read out from the markings.

Further advantages and embodiments can be seen in the accompanying drawings:

In the drawings:

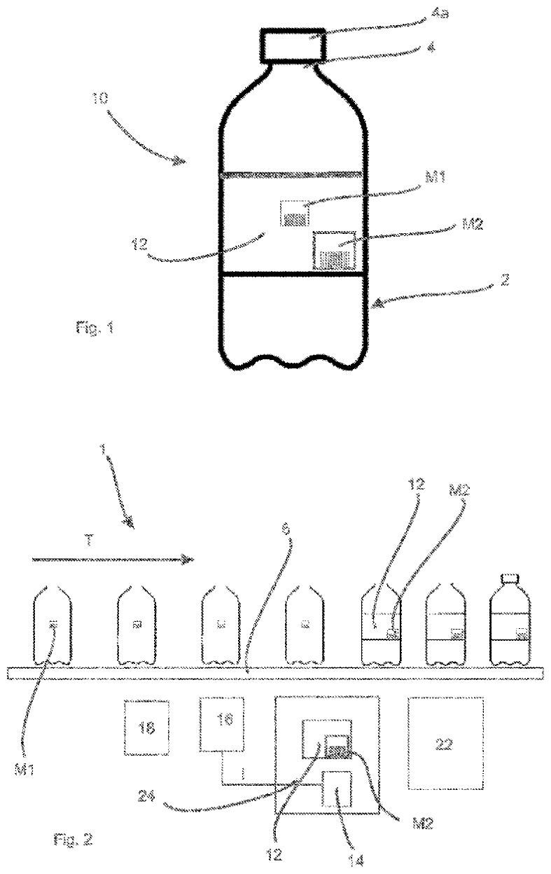

FIG. 1 shows a representation of a container according to the invention;

FIG. 2 shows a rough schematic representation of an apparatus for treating the containers.

FIG. 1 shows a rough schematic representation of a container 10. This container has a main body 2, as well as a mouth region 4, which has a reduced cross section compared to the main body. Reference sign 4a designates a container closure which is arranged on the container.

A decor element 12 in the form of a label is arranged on the container. Furthermore, a first marking M1 is arranged directly on the container 10 or its main body 2. Said first marking M1 is shown in dashed lines here because it is concealed by the decor element 12. A second marking M2 is arranged on the decor element 12.

Both markings M1, M2 are respectively suitable and intended to uniquely identify the container or reusable bottle 10. When the container is recycled, the decor element 12 with the marking M2 arranged thereon is detached from the container, while the marking on the container remains during the entire service life of the container 10.

FIG. 2 shows a schematic representation of an apparatus 1 according to the invention for treating containers. Reference sign 6 designates a transport device which transports the containers 10 in the transport direction. This transport device is shown here only roughly schematically. This transport device transports the containers 10 preferably individually. For this purpose, the transport device can also have holding devices (not shown) which hold or grip the containers for their transport. The transport device can also be composed of several transport units arranged in succession.

It can be seen here that the containers 10 are already provided with the first marking. Reference sign 16 designates a detection device which recognizes or reads the first marking. This detection device can output a signal and/or an information Ito a marking device 14, which is used when the marking M2 is created. The marking M2 can be applied to the label before labeling or even after the labeling process, for example, by means of an ink jet or laser marking unit. In addition, the marking M2 is preferably created in such a way that, during a later readout of the second marking, it is preferably also possible to deduce the first marking M1.

The identification of feature M1 and the application of the identifier M2 take place at different locations on the transport path. A control unit is provided which tracks both features and combines them at a location/point in time.

Reference sign 24 designates a treatment device, for example in a labeling machine, which applies the decor element 12 to the containers such as in the form of a label. Reference sign 14 designates roughly schematically the marking device, which in each case applies the second marking M2 to the decor elements. Subsequently, the decor elements 12 provided with the second marking M2 are arranged on the containers. Reference sign 22 designates a (first) treatment device which is designed here, for example, as a filling device which fills the containers. In addition, a closing device can also be provided which closes the filled containers provided with the decor elements 12.

However, it would also be conceivable for the containers to be initially filled (and possibly also closed) and only then to be provided with the decor elements or labels.

Reference sign 18 designates roughly schematically a storage device, such as a database in which information regarding the first markings to be read and/or with respect to the second markings M2 to be created can be stored.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1-10. (canceled)

11. A method for treating containers comprising the steps of:
providing a container which has at least one first marking which identifies this container;
determining at least one information associated with said first marking; and
attaching a second marking to the container, wherein the second marking is created taking into account the first marking and/or the determined information.

12. The method according to claim 11,
wherein
the second marking is linked to the first marking.

13. The method according to claim 11,
wherein
the container is provided with at least one decor element and the second marking is arranged on this decor element.

14. The method according to claim 13,
wherein
the decor element is selected from a group of decor elements containing labels, container closures and the like.

15. The method according to claim 11,
wherein
the first marking is selected from a group of markings containing matrix codes, barcodes or DotCodes.

16. The method according to claim 14,
wherein
the first marking is at least partially concealed by the decor element.

17. An apparatus for treating containers comprising a first treatment unit which treats the containers in a first predetermined manner and with a decorating device which provides the containers with a decor element and with a transport device which transports the containers in a predetermined transport direction,
the apparatus has a detection device arranged upstream of the decorating device in the transport direction, which detection device is suitable and intended to detect a first marking arranged on the containers and wherein a marking device is provided which is suitable and intended for applying a second marking on the decor element.

18. The apparatus according to claim 17,
wherein
the marking device applies the second marking taking into account the first marking.

19. The apparatus according to claim 17,
wherein
the apparatus has a storage device in which data for an association characteristic between the first marking and the second marking can be stored.

20. A reusable container with a main body, which forms a receiving volume for a foodstuff, and with a container mouth, wherein the reusable container has a first marking that can be read out by a read-out device and which identifies this reusable container,
wherein
the reusable container has a second marking which uniquely identifies this container.
